(19) United States
(12) Patent Application Publication
(10) Pub. No.: US 2007/0224524 A1
(43) Pub. Date: Sep. 27, 2007

(54) Method for manufacturing color filter of transflective liquid crystal display

(75) Inventor: Tzu-Min Yan, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/728,543

(22) Filed: Mar. 26, 2007

(30) Foreign Application Priority Data
Mar. 24, 2006 (TW) 95110322

(51) Int. Cl. G02F 1/1335; G02B 5/20

(52) U.S. Cl. 430/7; 349/106

(57) ABSTRACT

An exemplary method for manufacturing a color filter of a transflective liquid crystal display includes: providing a substrate; forming a plurality of black matrix units on the substrate; coating and patterning a first photo-resist layer, coating and patterning a second photo-resist layer, and coating and patterning a third photo-resist layer, in a selected sequence, using a slit mask, to respectively form red color units, green color units, and blue color units, each of the color units including a transmissive portion and two reflective portions adjacent two opposite sides of the transmissive portion, a thickness of the transmissive portion being greater than a thickness of each of the reflective portions.

### FIELD OF THE INVENTION

The present invention relates to methods for manufacturing color filters which can be used with transflective liquid crystal displays (LCDs).

### GENERAL BACKGROUND

Liquid crystal displays are in wide use as display devices capable of reducing the overall size, weight and thickness of electronic apparatuses in which they are employed. In general, liquid crystal displays can be divided into two categories—transmissive liquid crystal displays and reflective liquid crystal displays—according to whether the liquid crystal display uses an internal or an external light source.

A transmissive liquid crystal display generally displays images using light from a backlight module, and is usable under any ambient light conditions. Because the backlight module typically provides high brightness, the transmissive liquid crystal display correspondingly has high power consumption. Further, the backlight module generally has a short working lifetime.

Unlike the transmissive liquid crystal display, a reflective liquid crystal display utilizes ambient light from a natural light source or from an external artificial light source. The reflective liquid crystal display generally has a long working lifetime. However, the reflective liquid crystal display is ineffective or even useless when the external light source is inadequate or unavailable.

To overcome the above-described problems, a transflective liquid crystal display has been developed. The transflective liquid crystal display can compensate the respective shortcomings of the reflective liquid crystal display and the transmissive liquid crystal display. That is, the transflective liquid crystal display can selectively provide a reflective or transmissive mode of display.

Referring to FIG. 10, a typical transflective liquid crystal display 9 includes a liquid crystal panel 90 and a backlight module 91. The liquid crystal panel 90 includes an upper substrate 92, a color filter 93, an upper electrode layer 94, a liquid crystal layer 95, a lower electrode layer 96, an insulating layer 97, and a lower substrate 98, arranged in that order from top to bottom. The backlight module 91 is located below the lower substrate 98.

The color filter 93 is formed on a bottom surface (not labeled) of the upper substrate 92. The color filter 93 includes a plurality of black matrix units 932 regularly arranged on the upper substrate 92, and a plurality of color units 934 covering the black matrix units 932 and the upper substrate 92. Each color unit 934 includes a transmissive portion 936 and two reflective portions 938 abutting respective opposite sides of the transmissive portion 936. A thickness of the transmissive portion 936 is approximately equal to that of the reflective portions 938. The upper electrode layer 94 is formed on a bottom side of the color filter 93, and serves as a common electrode.

The insulating layer 97 is formed on a top surface (not labeled) of the lower substrate 98. The lower electrode layer 96 includes a plurality of transparent electrodes 962 respectively corresponding to the transmissive portions 936, and a plurality of reflective electrodes 964 corresponding to respective pairs of adjacent reflective portions 938.

A method for manufacturing the color filter 93 is described below. First, an upper substrate 92 is provided. Second, a plurality of black matrix units 932 are formed on the upper substrate 92. Third, a high purity red photo-resist layer is applied onto the upper substrate 92 having the black matrix units 932. The high purity red photo-resist layer is exposed and developed, thereby forming a plurality of transmissive portions 936 of red color units 934, arranged in a predetermined pattern. Fourth, a low purity red photo-resist layer is applied onto the upper substrate 92 having the black matrix units 932. The low purity photo-resist layer is exposed and developed, thereby forming a plurality of reflective portions 938 of the red color units 934, the reflective portions 938 abutting the respective transmissive portions 936. For example, in each red color unit 934, two red reflective portions 938 abut opposite sides of a red transmissive portion 936. Fifth, green color units 934 and blue color units 934 are formed by performing steps similar to those described above.

In the reflective mode, ambient light from an external light source such as sunlight passes through the upper substrate 92, the color filter 93, the upper electrode layer 94, and the liquid crystal layer 95 in that order, and is then reflected by the reflective electrodes 964. The light then passes back through the liquid crystal layer 95, the upper electrode layer 94, the color filter 93, and the upper substrate 92 in that order. That is, the ambient light passes through the color filter 93 twice.

In the transmissive mode, light from the backlight module 91 (i.e., backlight) passes through the lower substrate 98, the insulating layer 97, the transparent electrodes 962, the liquid crystal layer 95, the upper electrode layer 94, the color filter 93, and the upper substrate 92 in that order. That is, the incident light generally passes through the color filter 93 only once.

The backlight from the backlight module 91 is filtered only once by the color filter 93 in the transmissive mode, and the ambient light is filtered twice by the color filter 93 in the reflective mode. Therefore if the transmissive portions 936 and reflective portions 938 were layers made from photo-resist having the same purity, the transflective liquid crystal display 9 would have better color purity of viewed images in the reflective mode than in the transmissive mode.

Thus, to overcome the above-described potential color purity disparity, in the above-described method for manufacturing the color filter 93, the low purity photo-resist layers are used to form the reflective portions 938 of the color units 934. As a result, the differences in color purity as between the reflective portions 938 as formed and the respective transmissive portions 936 as formed compensate for the differences in color purity of viewed images that would otherwise exist as between the reflective mode and the transmissive mode.

However, in the above-described method, for each of the three different colors, two photo-resist layers with different color purity need to be separately coated on the upper substrate 92 to form the color units 934. Overall, a large number of separate coating steps are required, which makes the method laborious, time-consuming, and rather costly.

What is needed, therefore, is a method for manufacturing a color filter of a transflective liquid crystal display that can overcome the above-described deficiencies.

### SUMMARY

In one preferred embodiment, a method for manufacturing a color filter of a transflective liquid crystal display includes: providing a substrate; forming a plurality of black matrix units on the substrate; coating and patterning a first photo-resist layer, coating and patterning a second photo-resist layer, and coating and patterning a third photo-resist layer, in a selected sequence, using a slit mask, to respectively form red color units, green color units, and blue color units, each of the color units including a transmissive portion and two reflective portions adjacent two opposite sides of the transmissive portion, a thickness of the transmissive portion being greater than a thickness of each of the reflective portions.

Other novel features, advantages and aspects will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present method. In the drawings, like reference numerals designate corresponding parts throughout various views, and all the views are schematic.

FIG. 1 is a side, cross-sectional view of part of a transflective liquid crystal display, the liquid crystal display including a color filter made according to an exemplary embodiment of the present invention.

FIG. 2 is a flowchart summarizing the method for manufacturing a color filter according to the exemplary embodiment of the present invention.

FIG. 3 is a side, cross-sectional view relating to a first step in the method; namely, a step of providing a substrate.

FIG. 4 is a side, cross-sectional view relating to a subsequent step of forming a plurality of black matrix units on the substrate.

FIG. 5 is a side, cross-sectional view relating to a subsequent step of applying a photo-resist layer on the substrate having the black matrix units.

FIG. 6 is a side, cross-sectional view relating to a subsequent step of exposing the photo-resist layer using a slit mask.

FIG. 7 is a side, cross-sectional view relating to a subsequent step of forming a plurality of color units each including a transmissive portion and two reflective portions abutting opposite sides of the transmissive portion, a thickness of the transmissive portion being greater than that of the reflective portions.

FIG. 8 is a side, cross-sectional view relating to a subsequent step of forming a transparent protective layer on all the color units formed.

FIG. 9 is a side, cross-sectional view relating to a subsequent step of forming a transparent conductive layer on the transparent protective layer.

FIG. 10 is side, cross-sectional view of part of a conventional transflective liquid crystal display including a conventional color filter.

### DETAILED DESCRIPTION OF PREFERRED EMBODIMENTS

Reference will now be made to the drawings to describe preferred embodiments of the present invention in detail.

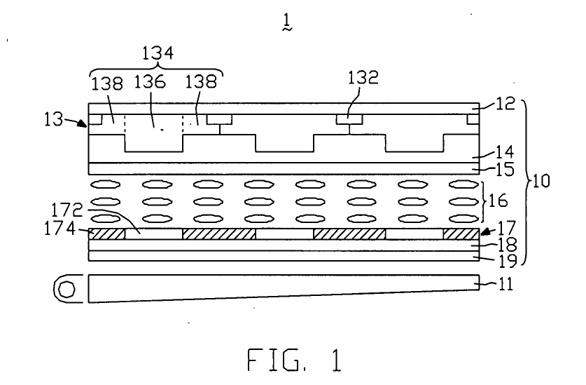

Referring to FIG. 1, a transflective liquid crystal display 1 includes a liquid crystal panel 10 and a backlight module 11. The liquid crystal panel 10 includes an upper substrate 12, a color filter 13, a transparent protective layer 14, an upper electrode layer 15, a liquid crystal layer 16, a lower electrode layer 17, an insulating layer 18, and a lower substrate 19, arranged in that order from top to bottom. The upper substrate 12, the transparent protective layer 14, the upper electrode layer 15, the insulating layer 18, and the lower substrate 19 are transparent. The backlight module 11 is located below the lower substrate 19, for providing a planar light source (backlight) for the liquid crystal panel 10.

The color filter 13 is formed on a bottom surface (not labeled) of the upper substrate 12. The color filter 13 includes a plurality of black matrix units 132 regularly arranged on the upper substrate 12, and a plurality of color units 134 covering the black matrix units 132 and the upper substrate 12. Each black matrix unit 132 serves to protect a corresponding thin film transistor (not shown) formed on the lower substrate 19 from being irradiated by ambient light. In addition, the black matrix unit 132 serves to prevent leakage of the backlight through intervals between electrical lines (not shown) formed on the lower substrate 19. The color units 134 are red, green, and blue (RGB) color units. Generally, each color unit 134 includes a transmissive portion 136, and two reflective portions 138 adjacent two opposite sides (not labeled) of the transmissive portion 136 respectively. A thickness of the reflective portions 138 is less than that of the transmissive portion 136. The transparent protective layer 14 in effect serves to fill gaps between the color unit 134 and the upper electrode layer 15. The upper electrode layer 15 is formed on the transparent protective layer 14, and serves as a common electrode.

The insulating layer 18 is formed on a top surface (not labeled) of the lower substrate 19. The lower electrode layer 17 is formed on the insulating layer 18. The lower electrode layer 17 includes a plurality of lower transparent electrodes 172 and lower reflective electrodes 174 alternately formed on the insulating layer 18. Two adjacent reflective portions 138 of each two adjacent color units 134 correspond to a respective one of the lower reflective electrodes 174. The transmissive portion 136 of each color unit 134 corresponds to a respective one of the lower transparent electrodes 172. The lower transparent electrodes 172 are preferably made of a transparent conductive material. The lower reflective electrodes 174 are generally made of an opaque metal having high reflectivity, such as aluminum (Al) or the like.

In a transmissive mode of display, incident light from the backlight module 11 passes through the lower substrate 19, the insulating layer 18, the lower transparent electrodes 172, the liquid crystal layer 16, the upper electrode layer 15, the transparent protective layer 14, the color filter 13, and the upper substrate 12 in that order.

In a reflective mode of display, ambient light from an external light source such as sunlight passes through the upper substrate 12, the color filter 13, the transparent protective layer 14, the upper electrode layer 15, and the liquid crystal layer 16 in that order, and is then reflected by the lower reflective electrodes 174 to pass back through the liquid crystal layer 16, the upper electrode layer 15, the transparent protective layer 14, the color filter 13, and the upper substrate 12 in that order.

Thus, in the transmissive mode, the backlight passes through the color filter 13 only once. In the reflective mode, the ambient light passes through the color filter 13 twice. The thickness of the reflective portions 138 that the ambient light passes through is less than the thickness of the transmissive portions 136 that the backlight passes through. That is, there can be identical color purity between the reflective mode and the transmissive mode when an appropriate ratio of the thickness of the reflective portions 138 to the thickness of the transmissive portion 136 of each color unit 134 is configured. In one example, the thickness of the reflective portions 138 is one-half the thickness of the transmissive portion 136.

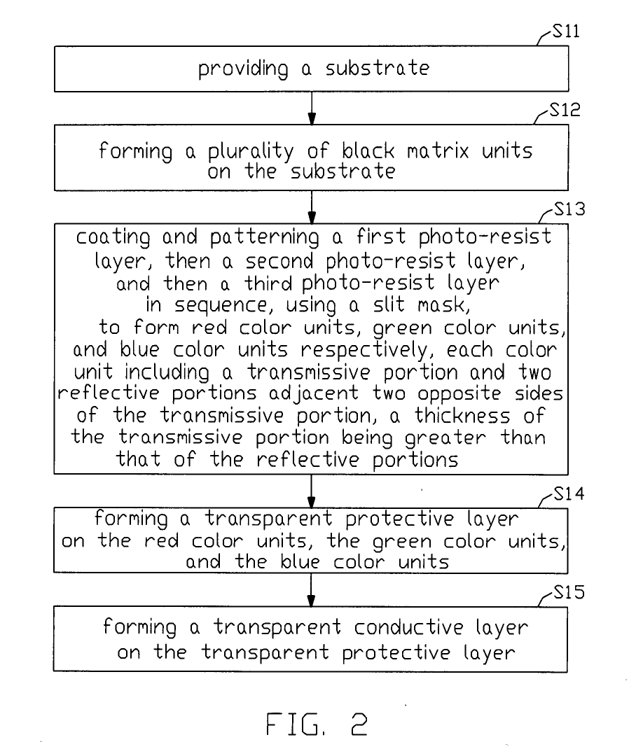

Referring to FIG. 2, a flowchart summarizing an exemplary method for manufacturing the color filter 13 is shown. The method includes: step S11, providing a substrate; step S12, forming a plurality of black matrix units on the substrate; step S13, coating and patterning a first photo-resist layer, coating and patterning a second photo-resist layer, and coating and patterning a third photo-resist layer in sequence on the substrate having the black matrix units, using a slit mask, to form red color units, green color units, and blue color units respectively, each color unit including a transmissive portion and two reflective portions adjacent two opposite sides of the transmissive portion respectively, a thickness of the transmissive portion being greater than that of the reflective portions; step S14, forming a transparent protective layer on the red, green, and blue color units; and step S15, forming a transparent conductive layer on the transparent protective layer.

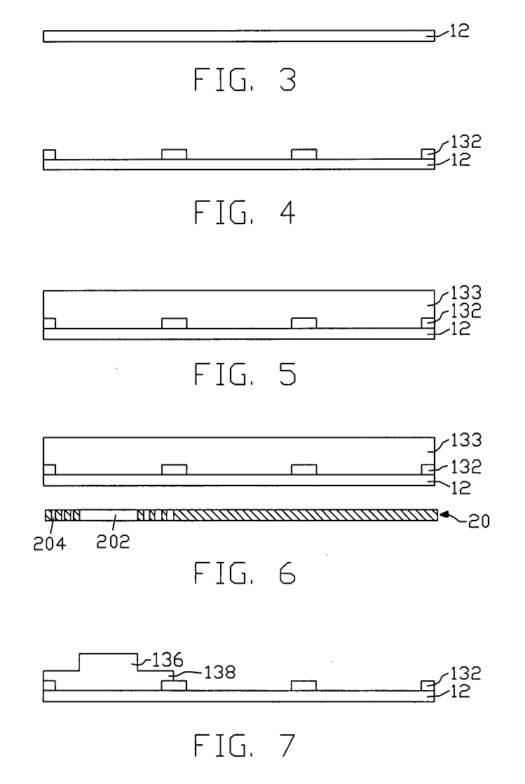

Referring also to FIG. 3, in step S11, a substrate 12 is provided. The substrate 12 acts as a carrier of other elements. The substrate 12 is transparent and insulating, and is generally made from glass with a relatively low concentration of alkali ions.

Referring also to FIG. 4, in step S12, a plurality of black matrix units 132 are formed on the substrate 12. Firstly, a photosensitive black organic material is deposited on the substrate 12, thereby forming a black organic layer. The photosensitive black organic material can be a positive type. In such case, portions of the photosensitive black organic material subsequently exposed to light are generally removed by developing; i.e., chemically treating the exposed portions. In an alternative embodiment, the photosensitive black organic material can be a negative type. In such case, portions of the photosensitive black organic material subsequently exposed to light are generally retained in a developing step. Secondly, a mask (not shown) having light-transmitting portions and light-shielding portions is placed over the black organic layer. Subsequently, light irradiates portions of the black organic layer through the light-transmitting portions of the mask. Then the light-exposed black organic layer is developed, whereby a plurality of black matrix units 132 on the substrate 12 are obtained. Generally, the black matrix units 132 are formed in positions that eventually become positions between adjacent R, G, B color units 134, in order to screen light along respective boundaries of pixel electrodes that are eventually formed. Each of the black matrix units 132 is typically formed of a metal thin film, a carbon-based organic material, a double layer structure of chromium (Cr) and chromium-oxide (CrOx), or photosensitive resin. The metal thin film can for example be made of chromium (Cr). In the double layer structure of Cr and CrOx, x is preferably in the range from 1.3 to 1.7. Thus, the black matrix units 132 cooperatively form a patterned lower reflection layer, with the black matrix units 132 having uniform reflectivity.

Referring also to FIG. 5 through FIG. 7, in step S13, a plurality of photo-resist layers are coated in sequence on the substrate 12 having the black matrix units 132. After the coating of each photo-resist layer, the photo-resist layer is patterned with a slit mask 20. Thereby, a plurality of red color units 134, green color units 134, and blue color units 134 are formed. For example, firstly, a red photo-resist layer 133 is applied onto the substrate 12 having the black matrix units 132, and is patterned with a slit mask 20 to form the red color units 134. The red photo-resist layer 133 generally includes pigment, acrylic resin, and photosensitive material. In the illustrated embodiment, the red photo-resist layer 133 is a negative photo-resist layer. The slit mask 20 includes light-transmitting portions and light-shielding portions. The light-transmitting portions each include a wide opening 202, and a plurality of slits 204 located at two opposite sides of the wide opening 202 respectively. Thus, in general, exposure via the wide openings 202 is much greater than that via the slits 204. The slit mask 20 is positioned below the substrate 12, and the substrate 12 is aligned with the slit mask 20. Then the red photo-resist layer 133 is exposed. Portions of the red photo-resist layer 133 corresponding to the wide openings 202 are fully hardened due to full exposure, portions of the red photo-resist layer 133 corresponding to the slits 204 are partially hardened due to less exposure, and unexposed portions of the red photo-resist layer 133 corresponding to the light-shielding portions are not hardened at all. The exposed red photo-resist layer 133 is then washed with a developer. Thereby, the fully hardened portions of the exposed red photo-resist layer 133 are retained to become the transmissive portions 136, the partially hardened portions of the exposed red photo-resist layer 133 are retained to become the reflective portions 138, and the unhardened portions of the red photo-resist layer 133 that were not exposed at all are completely removed. Thus, a plurality of red color units 134 are formed.

After the red color units 134 are formed, the green color units 134 and blue color units 134 are then formed in that sequence, by performing steps similar to those described above with due alteration of details. Each color unit 134 includes a transmissive portion 136, and two reflective portions 138 adjacent two opposite sides of the transmissive portion 136 respectively. A thickness of the reflective portions 138 is less than that of the transmissive portion 136.

In an alternative embodiment, each of the photo-resist layers can be a positive photo-resist layer. In such case, an alternative slit mask different from the slit mask 20 is used. The alternative slit mask includes light-transmitting portions and light-shielding portions. The light-transmitting portions each include a wide opening, and a plurality of slits located at two opposite sides of the wide opening respectively. The alternative slit mask is positioned above the substrate 12. Portions of each photo-resist layer corresponding to the wide openings are completely removed, portions of each photo-resist layer corresponding to the slits 204 eventually become the reflective portions 138, and portions of each photo-resist layer corresponding to the light-shielding portions eventually become the transmissive portions 136.

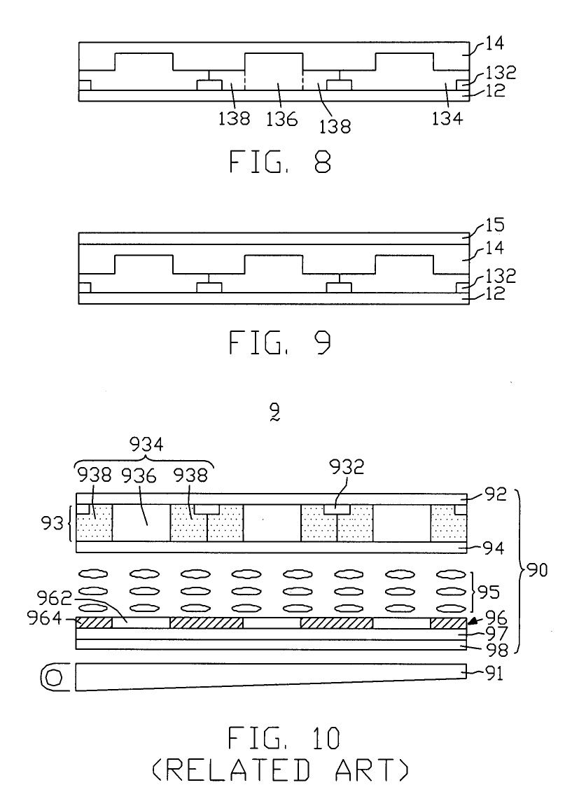

Referring also to FIG. 8, in step S14, a transparent protective layer 14 is formed on the substrate 12 having the black matrix units 132 and the color units 134. Typically, in an initial phase, transparent insulating material is deposited on the reflective portions 138, which are inmost portions of the color units 134. That is, gaps between transmissive portions 136 of adjacent color units 134 are filled. In a subsequent phase, further transparent insulating material is deposited on the transmissive portions 136 and portions of the transparent insulating material already deposited. Thus, the transparent protective layer 14 has a uniform plane surface that is farthest from the substrate 12. In an alternative embodiment, transparent insulating material is deposited on the reflective portions 138 only. Thereby, outmost surfaces of the transmissive portions 136 remain exposed, and these outmost surfaces together with exposed surfaces of the deposited transparent insulating material cooperatively form a uniform plane surface.

Referring also to FIG. 9, in step S15, a transparent conductive layer 15 is formed on the transparent protective layer 14. The transparent conductive layer 15 is generally made from indium tin oxide (ITO) or indium zinc oxide (IZO), and is usually formed on the transparent protective layer 14 by a sputter method. An electric field is created in a vacuum cavity filled with argon gas, such that arc discharge of the argon gas is produced. Argon ions (Ar⁺) with kinetic energy bombard a surface of (say) an ITO target on a cathode. ITO atoms are sputtered onto a surface of the transparent protective layer 14 and progressively accumulate to form the transparent conductive layer 15. Preferably, a magnetic field is created in order to change a direction of movement of the argon ions. In the magnetic field, magnetic lines of force are parallel to the surface of the ITO target. This can increase by several-fold the quantity of argon ions bombarding the ITO target. Thus the ITO atoms can be sputtered onto the transparent protective layer 14 at a low temperature even if a pressure of the argon gas is low.

In the above-described exemplary method for manufacturing the color filter 13, a plurality of color units 134 of the one color can be simultaneously formed by using the slit mask 20 having the wide openings 202 and the slits 204. That is, the transmissive portions 136 and the reflective portions 138 of the color units 134 of the one color can be simultaneously formed. Therefore when a total of three color units 134 (e.g. R, G, B) is formed, only three exposure processes using the slit mask 20 are required. Further, in a typical process, the same slit mask 20 can be used for all three exposure processes. Therefore the method for manufacturing the color filter 13 is simpler than conventional methods, and can be performed inexpensively. Moreover, the thickness of the reflective portions 138 of the color units 134 can be controlled by controlling the width of the slits 204.

Further or alternative embodiments may include the following. In one example, a semitransparent mask can be used to control the respective thicknesses of the reflective portions and the transmissive portions, with the semitransparent mask providing appropriate distribution of exposure intensities.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A method for manufacturing a color filter of a transflective liquid crystal display, the method comprising:
providing a substrate;
forming a plurality of black matrix units on the substrate; and
coating and patterning a first photo-resist layer, coating and patterning a second photo-resist layer, and coating and patterning a third photo-resist layer, in a selected sequence, using a slit mask, to respectively form red color units, green color units, and blue color units, each of the color units comprising a transmissive portion and two reflective portions adjacent two opposite sides of the transmissive portion, a thickness of the transmissive portion being greater than a thickness of each of the reflective portions.

2. The method as claimed in claim 1, wherein the slit mask comprises a plurality of light-transmitting portions and a plurality of light-shielding portions.

3. The method as claimed in claim 2, wherein the light-transmitting portions each comprise a wide opening and a plurality of slits located at each of opposite sides of the wide opening respectively.

4. The method as claimed in claim 1, wherein the photo-resist layers are negative photo-resist layers.

5. The method as claimed in claim 4, wherein portions of each of the photo-resist layers corresponding to the wide openings form the transmissive portions, and portions of each of the photo-resist layers corresponding to the slits form the reflective portions.

6. The method as claimed in claim 1, wherein the photo-resist layers are positive photo-resist layers.

7. The method as claimed in claim 6, wherein portions of each photo-resist layer corresponding to the slits form the reflective portions, and portions of each photo-resist layer corresponding to the light-shielding portions form the transmissive portions.

8. The method as claimed in claim 1, further comprising forming a transparent protective layer on the red, green and blue color units.

9. The method as claimed in claim 8, further comprising forming a transparent conductive layer on the transparent protective layer.

10. The method as claimed in claim 9, wherein the transparent conductive layer is made from indium tin oxide or indium zinc oxide.

11. The method as claimed in claim 6, further comprising forming a transparent protective layer on the reflective portions of the red, green and blue color units.

12. The method as claimed in claim 11, further comprising forming a transparent conductive layer on the transmissive portions of the red, green and blue color units and the transparent protective layer.

13. A structure of a liquid crystal display comprising:
a liquid crystal panel and a backlight module,
the liquid crystal panel includes an upper substrate, a color filter, an upper electrode layer, a liquid crystal layer, a lower electrode layer, an insulating layer, and a lower substrate, arranged in that order from top to bottom,
the backlight module located below the lower substrate; wherein
a lower boundary line of the color filter is non-linear.

14. The structure as claimed in claim 13, wherein said boundary line is configured to be in an up-and-down step form.

15. The structure as claimed in claim 14, wherein a protective layer is located between the color filter and the upper electrode layer and share said boundary line with the color filter.
